(19) United States
(12) Patent Application Publication
(10) Pub. No.: US 2026/0154451 A1
(43) Pub. Date: Jun. 4, 2026

(54) DEVICE AND METHOD FOR PROCESSING PARTIALLY ENCRYPTED IMAGE DATA BASED ON DEEP LEARNING

(71) Applicants: KONGJU NATIONAL UNIVERSITY INDUSTRY-UNIVERSITY COOPERATION FOUNDATION, Gongju-si (KR); Daegu Gyeongbuk Institute of Science and Technology, Daegu (KR)

(72) Inventors: Chang Ho SEO, Daejeon (KR); Soo Yong JEONG, Gongju-si (KR); Woo Sang IM, Sejong-si (KR); In Kyu MOON, Daegu (KR); Antoinette Deborah MARTIN, Daegu (KR); On Gee JEONG, Daegu (KR)

(73) Assignees: KONGJU NATIONAL UNIVERSITY INDUSTRY-UNIVERSITY COOPERATION FOUNDATION, Gongju-si (KR); Daegu Gyeongbuk Institute of Science and Technology, Daegu (KR)

(21) Appl. No.: 19/403,804

(22) Filed: Nov. 29, 2025

(30) Foreign Application Priority Data
Nov. 29, 2024 (KR) 10-2024-0174919

(51) Int. Cl. G06F 21/62; G06F 21/60; G06T 11/00; G06V 10/40; G06V 10/764; G06V 10/77; G06V 10/82; G06V 20/52; G06V 20/62; G06V 40/16; G06V 40/50

(52) U.S. Cl. CPC G06F 21/6254; G06F 21/602; G06T 11/00; G06V 10/40; G06V 10/764; G06V 10/7715; G06V 10/82; G06V 20/635; G06V 20/52; G06V 40/168; G06V 40/53

(57) ABSTRACT

A device and method for processing partially encrypted image data based on deep learning are disclosed. According to an embodiment of the present disclosure, a method for processing image data comprises: receiving a first image; generating a second image by partially encrypting the first image and storing the second image in a memory; inputting the second image into a trained model to generate at least one of caption information and classification information and storing the generated information in the memory; and providing at least one of the caption information and the classification information.

### CROSS-REFERENCE TO RELATED APPLICATION

The present application claims priority under 35 U.S.C. § 119 (a) to Korean patent application number 10-2024-0174919 filed on Nov. 29, 2024, in the Korean Intellectual Property Office, the entire disclosure of which is incorporated by reference herein.

### BACKGROUND

### 1. Technical Field

The present disclosure relates to a device and method for processing partially encrypted image data based on deep learning, and more particularly, to a method for protecting personal information included in image data while generating and classifying captions.

### 2. Related Art

Recently, various devices such as smartphones, cameras, and image sensors have been utilized in a wide range of fields and shared over networks. However, since image data may include sensitive personal information, such as a person's face, which should not be disclosed, technologies for securely protecting image data have been developed.

In Korean Registered Patent No. 10-2678533 (registered on Jun. 21, 2024, titled “A Method and Device for Blurring Objects in Images Using Artificial Intelligence”), a technology is disclosed in which candidate regions are detected from image data including personal or sensitive information, object recognition is performed in the candidate regions, and when an object is recognized, the corresponding region is blurred.

However, such blurring techniques permanently degrade the resolution of the corresponding region to a low resolution, making it difficult to restore the original image data from the blurred image data.

Accordingly, there has been a limitation in that restoration to the original image data is difficult when necessary.

In addition, in the related art, different techniques have been applied respectively for generating or classifying captions for image data. As a result, systems for processing image data become relatively complex, and both processing time and cost increase.

### SUMMARY

In view of the foregoing problems, the present disclosure is directed to providing a deep learning-based technology for generating and classifying captions for partially encrypted image data, which processes personal information or the like included in image data while allowing restoration to the original image data when necessary.

Another object of the present disclosure is to provide a deep learning-based technology for generating and classifying captions for partially encrypted image data, which enables image data processing for personal information protection and allows captions for the image data to be generated and classified collectively.

To solve the above technical problems, a deep learning-based method for processing partially encrypted image data, implemented by a computer, according to an exemplary embodiment of the present disclosure, may include receiving a first image; partially encrypting at least a portion of the first image to generate a second image in the form of complex numbers; extracting a first feature map and a second feature map by respectively inputting a real component and an imaginary component of the second image into a first encoder and a second encoder; generating caption information by inputting a feature vector, generated by concatenating and flattening the first feature map and the second feature map, into a transformer-based caption generation model; generating classification information by inputting the second image into a Vision Transformer (ViT)-based classification model; and outputting or storing at least one of the caption information and the classification information, and the partially encrypted region may correspond to a predetermined region requiring personal information protection.

In an exemplary embodiment of the present disclosure, the partial encryption may be performed according to a Double Random Phase Encoding (DRPE) scheme, and a first phase mask and a second phase mask used in the DRPE process may be composed of random phases that are independently generated from each other.

In an exemplary embodiment of the present disclosure, an encrypted region of the second image may be stored separately as a real component and an imaginary component.

In an exemplary embodiment of the present disclosure, a real component and an imaginary component of the second image may be respectively input into a first encoder and a second encoder based on a ResNet-50 architecture to extract a first feature map and a second feature map.

In an exemplary embodiment of the present disclosure, the transformer-based caption generation model may include an encoder-decoder structure that performs cross-attention between feature vectors of a real component and an imaginary component.

In an exemplary embodiment of the present disclosure, the predetermined region requiring personal information protection may include a face, a body, or a sensitive object region, and an encryption target region may be automatically selected according to predefined coordinates or object recognition results.

In an exemplary embodiment of the present disclosure, the second image may be divided into a plurality of patches, each patch may be converted into a position-embedded input vector and input into a Vision Transformer (ViT)-based classification model, and the classification model may output a classification result through a Multi-Layer Perceptron (MLP) head.

In an exemplary embodiment of the present disclosure, the first image may be an image requiring privacy protection, and may be one of a surveillance image, a medical image, and an autonomous driving image.

In addition, to solve the above technical problems, a computer-readable medium according to an exemplary embodiment of the present disclosure may include a non-transitory computer-readable medium storing instructions executed by a processor to perform any of the methods described above.

In addition, to solve the above technical problems, an image data processing device according to an exemplary embodiment of the present disclosure may include a memory storing a plurality of instructions; and a processor configured to execute the instructions, and the processor may be configured to: receive a first image; partially encrypt at least a portion of the first image using a Double Random Phase Encoding (DRPE) scheme to generate a second image in the form of complex numbers; extract a first feature map and a second feature map by respectively inputting a real component and an imaginary component of the second image into a first encoder and a second encoder; generate caption information by inputting a feature vector, generated by concatenating and flattening the first feature map and the second feature map, into a transformer-based caption generation model; generate classification information by inputting the second image into a Vision Transformer (ViT)-based classification model; and transmit at least one of the caption information and the classification information to an external terminal or output it through a display.

The present disclosure can prevent the leakage of personal information through image data by partially encrypting the image data, while allowing the original image data to be restored through decryption when necessary.

In addition, the partially encrypted image data, unlike fully encrypted data or conventionally blurred sensitive regions, enables caption generation and classification, and thus can be effectively applied in various fields.

Furthermore, the present disclosure can improve the convenience of image data processing by generating captions for partially encrypted image data and classifying the same.

### BRIEF DESCRIPTION OF THE DRAWINGS

FIG. 1 illustrates an image data processing device according to an exemplary embodiment of the present disclosure.

FIG. 2 illustrates a part of the configuration of the image data processing device according to an exemplary embodiment of the present disclosure.

FIG. 3 illustrates another part of the configuration of the image data processing device according to an exemplary embodiment of the present disclosure.

FIG. 4 illustrates an image data processing method according to an exemplary embodiment of the present disclosure.

FIG. 5 illustrates in detail a part of the configuration of the image data processing method according to an exemplary embodiment of the present disclosure.

FIG. 6 illustrates in detail another part of the configuration of the image data processing method according to an exemplary embodiment of the present disclosure.

FIG. 7 illustrates a partial encryption process and result according to an exemplary embodiment of the present disclosure.

FIG. 8 illustrates a partial encryption process and result according to an exemplary embodiment of the present disclosure.

FIGS. 9A to 9D illustrate captions generated by the image data processing method according to an exemplary embodiment of the present disclosure, together with captions generated by another method and ground-truth captions.

### DETAILED DESCRIPTION OF THE EMBODIMENTS

The present disclosure may be modified in various ways and may have several embodiments, and specific embodiments will be illustrated in the drawings and described in detail below. However, it should be understood that the present disclosure is not limited to the specific embodiments described herein, but includes all modifications, equivalents, and alternatives falling within the spirit and scope of the present disclosure.

In the following description of the present disclosure, detailed descriptions of well-known technologies may be omitted when it is determined that such descriptions could obscure the gist of the present disclosure.

Hereinafter, exemplary embodiments of the present disclosure will be described in detail with reference to the accompanying drawings.

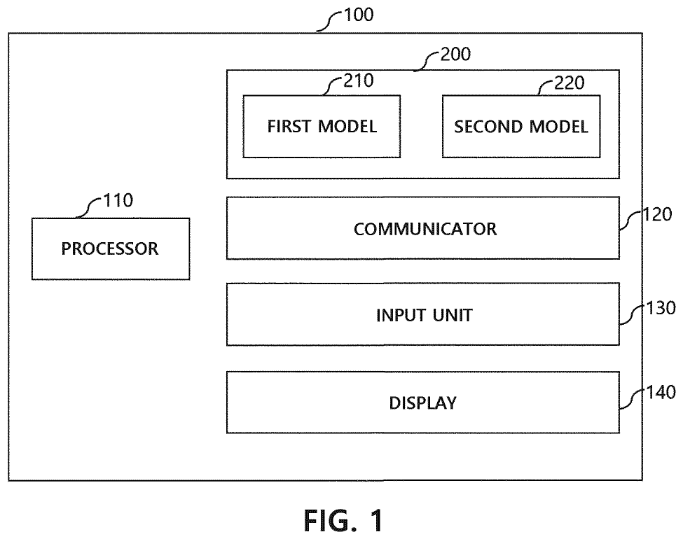

FIG. 1 illustrates an image data processing device 100 according to an exemplary embodiment of the present disclosure.

Referring to FIG. 1, an image data processing device 100 according to an exemplary embodiment of the present disclosure includes a processor 110, a memory 200, a communicator 120, an input unit 130, and a display 140.

The processor 110 executes at least one instruction, program, or algorithm stored in the memory 200. An artificial intelligence (AI) model may be configured with information including at least one instruction, program, and algorithm. The processor 110 may provide input information to the AI model to extract inference information. In an exemplary embodiment of the present disclosure, it will be described that the processor 110 executes the AI model recorded in the memory 200; however, the present disclosure is not necessarily limited thereto, and the processor 110 may constitute a part of the AI model.

The processor 110 transmits control signals to the communicator 120, the input unit 130, and the display 140, and may receive reception information from the communicator 120 and input information from the input unit 130.

The memory 200 may store information necessary for performing an image data processing method and information related to a first model 210 and a second model 220. The memory 200 may store information temporarily or for a long term.

The memory 200 includes a non-volatile storage for storing data (information) regardless of whether power is supplied or not, and a volatile memory in which data to be processed by the processor 110 is loaded and cannot retain data unless power is provided. The storage includes a flash memory, a hard-disc drive (HDD), a solid-state drive (SSD), a read only memory (ROM), or the like, and the memory includes a buffer, a random access memory (RAM), or the like.

The communicator 120 may be connected to an external terminal to transmit and receive information with the external terminal. For example, the communicator 120 may receive image data from the external terminal. For example, the communicator 120 may transmit caption information or classification information corresponding to the image data to the external terminal.

The communicator 120 may be configured to perform wireless communication such as 5G (fifth generation communication), LTE-A (long term evolution-advanced), LTE (long term evolution), Wi-Fi (wireless fidelity), or Bluetooth, but is not necessarily limited to these communication methods.

The input unit 130 generates input data in response to a user input. The input data may include a request for processing image data.

The input unit 130 may include at least one input means. For example, the input unit 130 may be implemented as a keyboard, keypad, dome switch, touch panel, touch key, mouse, or menu button, but is not necessarily limited thereto. The input unit 130 may also be implemented as a touch screen integrated with the display 140.

The display 140 may output, visually or audibly, caption information or classification information corresponding to the image data.

The display 140 may be implemented as a liquid crystal display (LCD), a light emitting diode (LED) display, an organic light emitting diode (OLED) display, a micro electro mechanical systems (MEMS) display, or an electronic paper display, but is not necessarily limited thereto.

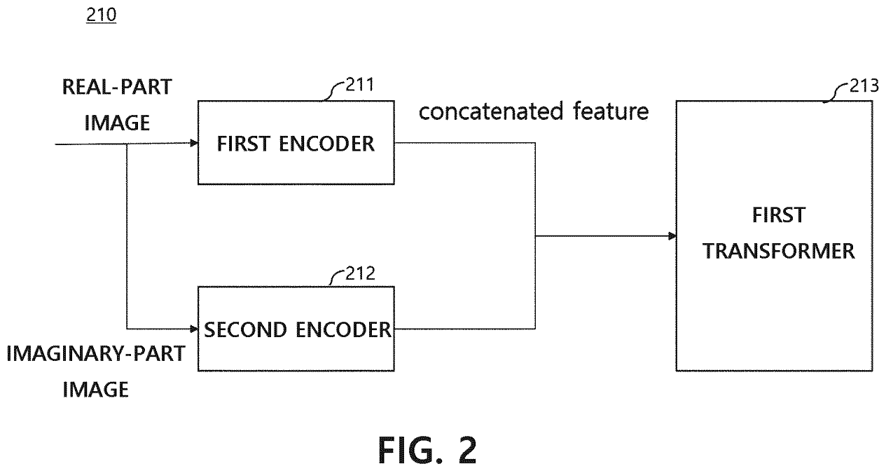

FIG. 2 schematically illustrates a configuration of the first model 210.

The first model 210 may be a deep learning model trained to infer a caption describing an image from an input image.

The first model 210 includes a first encoder 211, a second encoder 212, and a first transformer 213. A detailed description of the operation of the first model 210 will be given in connection with the image data processing method described later.

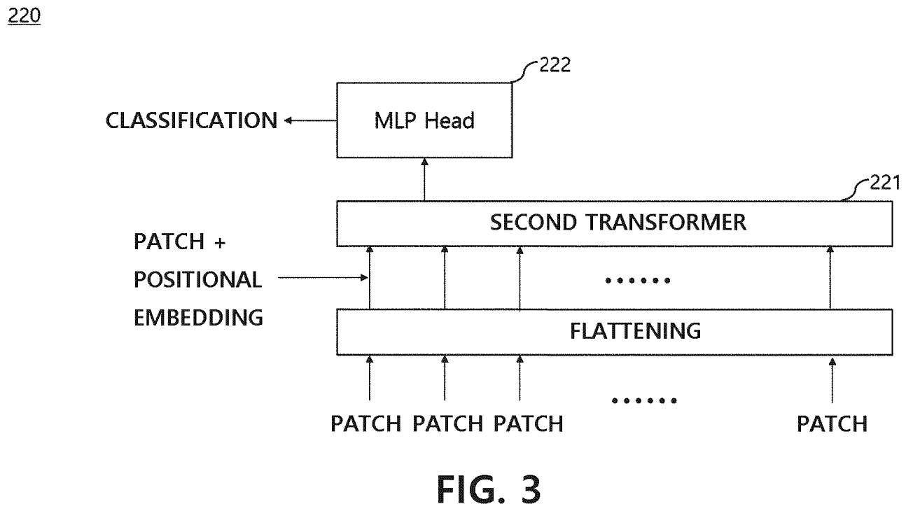

FIG. 3 schematically illustrates a configuration of the second model 220.

The second model 220 may be a deep learning model trained to infer classification information for classifying an image from an input image.

The second model 220 includes a second transformer 221 and an MLP (multi-layer perceptron) head 222. A detailed description of the operation of the second model 220 will be given in connection with the image data processing method described later.

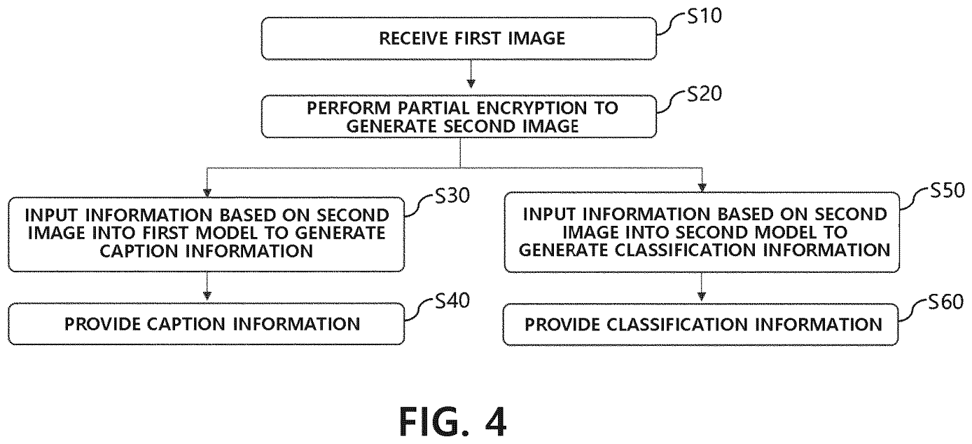

FIG. 4 illustrates an image data processing method according to an exemplary embodiment of the present disclosure.

The image data processing method according to an exemplary embodiment of the present disclosure may be executed by the image data processing device 100 according to an exemplary embodiment of the present disclosure. However, the implementation of the image data processing method is not necessarily limited thereto.

The processor 110 receives a first image (S10). The first image may be an original image before encryption processing is performed or a preprocessed version of the original image. The preprocessing may include processing such as adjusting the resolution or size of the image and applying filtering.

The processor 110 may receive the first image from an external terminal through the communicator 120.

The first image may be any one of a surveillance image, a medical image, or an autonomous driving image. The first image is not necessarily limited to the above-described embodiments and may be applied without limitation to images requiring personal information protection.

The processor 110 may alternatively perform step S10 by loading a first image previously stored in the memory 200.

The processor 110 performs partial encryption on the first image to generate a second image (S20). The second image may refer to an image or information in which a part of the image is encrypted. The second image may include two images corresponding to the original image.

The processor 110 may obtain the second image by inputting the first image into a double random phase encoding (DRPE) process previously stored in the memory 200.

The DRPE is an optical-based encryption scheme. The DRPE can encrypt large-scale data, such as image data, at high speed by using parallel processing.

The original image is converted into fixed white noise by using an RPM (Random Phase Mask) and a 4f optical system. The input image and the RPM (Random Phase Mask) must have the same size to ensure pixel-by-pixel multiplication.

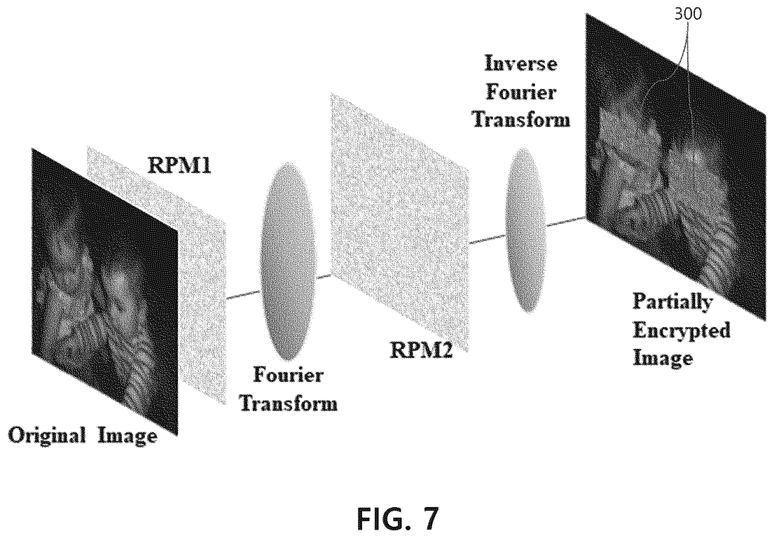

FIG. 7 illustrates a partial encryption process and result according to an exemplary embodiment of the present disclosure. Referring to FIG. 7, the present disclosure may perform partial encryption in a double RPM configuration. FIG. 7 shows an encrypted region 300, which is a target region for partial encryption. In FIG. 7, a region requiring personal information protection, such as a face, may be selected as the partial encryption target. For this purpose, an algorithm for selecting an encryption target region may be stored in the memory 200.

Equation 1 below illustrates a partial encryption process used in the present disclosure.

$$g ( x , y ) = IFT \{ FT \{ f ( x , y ) exp [ j 2 π t ( x , y ) ] \} * exp [ j 2 π s ( μ , v ) ] \} \qquad [ Equation 1 ]$$

In Equation 1, g(x, y) represents the encrypted image, and FT and IFT denote a Fourier transform and an inverse Fourier transform, respectively.

In addition, f(x, y) represents the input image, j denotes an imaginary unit, exp[j2πt(x, y)] represents RPM1, and exp[j2πs(μ, v)] represents RPM2.

Partial encryption selects and encrypts specific regions or features that include sensitive information such as personal information, while preserving the overall structure and context of the image. For example, the partially encrypted region may include a face, a body, or other predefined sensitive object regions. The partially encrypted region may be automatically selected according to predefined coordinates or object recognition results.

By using partial encryption, personal information in the image can be protected while maintaining other recognizable features, thereby allowing accurate captions to be generated thereafter.

In the second image, regions other than the encrypted region may be composed of the same information as the original image.

The partially encrypted region is stored as information composed of complex numbers, as shown in [Equation 1].

The processor 110 may separate the second image into a real part and an imaginary part and store them in the memory 200.

The real part of the second image includes a real component of the original portion and the encrypted (masked) information.

The imaginary part of the second image includes an imaginary component of the original portion and the encrypted (masked) information. However, the present disclosure is not necessarily limited thereto, and regions other than the encrypted region may be processed as blanks.

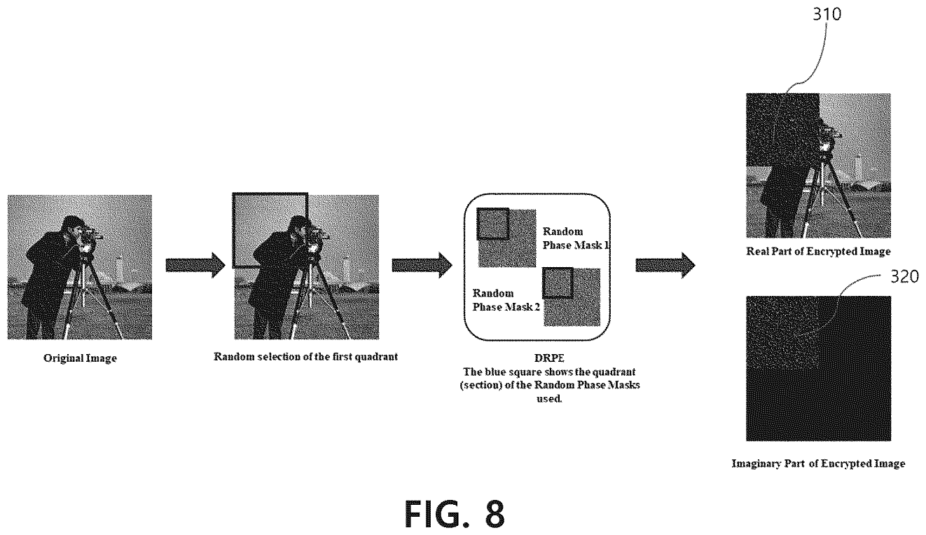

FIG. 8 illustrates a partial encryption process and result according to an exemplary embodiment of the present disclosure.

Referring to FIG. 8, the encryption target region may be one of the four divided regions of the original image, or a partial region selected based on a central coordinate. That is, the method for determining the encryption target region may be flexibly selected in consideration of the necessity of personal information or characteristics of the artificial intelligence model.

In FIG. 8, a real part 310 and an imaginary part 320 of the second image are represented as image information.

The second image, on which partial encryption has been performed, may be input into the first model 210 or the second model 220 to be utilized for inferring desired information.

The processor 110 inputs information based on the second image into the first model 210 to generate caption information (S30).

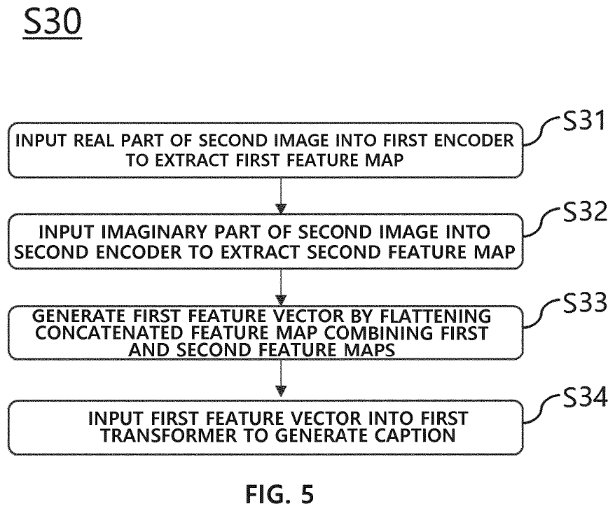

FIG. 5 illustrates step S30 in detail.

The processor 110 inputs a real part of the second image into the first encoder 211 to extract a first feature map (S31). The first feature map may be temporarily or long-term stored in the memory 200.

The first encoder 211 may include a structure of ResNet50, which is a convolutional neural network (CNN). The first encoder 211 extracts a feature map of the input image.

The processor 110 inputs an imaginary part of the second image into the second encoder 212 to extract a second feature map (S32). The second feature map may be temporarily or long-term stored in the memory 200.

The second encoder 212 may include a structure of ResNet50, which is a convolutional neural network (CNN). The second encoder 212 extracts a feature map of the input image.

Specifically, the structure used in a dual-stream encoder composed of two parallel encoders is based on a ResNet50 architecture. The ResNet50 architecture consists of 50 layers including residual blocks with 1×1, 3×3, and 1×1 convolutional layers, and its computational efficiency, depth, skip connections, performance, and transfer learning capability enable various types of image processing.

In the ResNet50 architecture of the present disclosure, the final pooling layer, the fully connected layer, and the Softmax layer are removed, and features may be extracted from the last convolutional layer.

An adaptive average pooling layer of 14×14 may be applied to the output of the last convolutional layer to obtain a final size of B×14×14×2048, where B denotes a batch size.

Pre-trained weights of the ResNet50 layers are used to initialize the model layers and may be fine-tuned during subsequent training. This allows the model to adapt to partially encrypted data.

The processor 110 concatenates the first feature map and the second feature map, flattens them, and generates a first feature vector (S33). The first feature vector may be temporarily or long-term stored in the memory 200.

The processor 110 inputs the first feature vector into the first transformer 213 to generate caption information. The first transformer 213 has an encoder-decoder structure. Specifically, the first transformer 213 may include an encoder-decoder structure that performs cross-attention between feature vectors of the real component and the imaginary component.

The encoder of the first transformer 213 receives an input of size 196×4096, where 196 represents a flattened 14×14 feature map, and 4096 represents a dimension generated by concatenating the outputs of the dual-stream encoder.

The decoder of the first transformer 213 receives an input sequence of size 52×300, where 52 represents a maximum (padded) sequence length, and 300 represents an embedding dimension.

As such, the first transformer 213 may generate a caption that has been trained to match features extracted by the dual-stream encoder. The features extracted by the dual-stream encoder may include connected features of a portion of the original image and an encrypted portion. The first transformer 213 may be trained to generate a corresponding caption from features of a partially encrypted image.

The processor 110 may provide the generated caption information (S40). Specifically, the processor 110 may display the generated caption information on the display 140 or transmit it to an external terminal (not shown).

The processor 110 inputs information based on the second image into the second model 220 to generate classification information (S50).

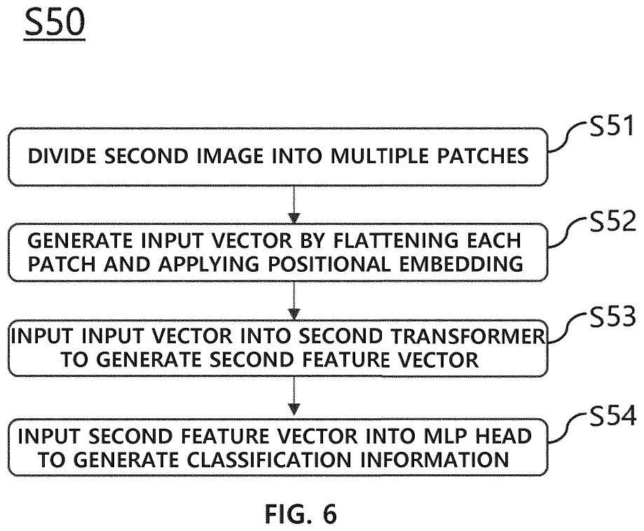

FIG. 6 illustrates step S50 in detail.

The processor 110 divides the second image into a plurality of patches (S51). Here, the second image may refer only to the real part, but is not necessarily limited thereto. The second image may also use the imaginary part in which a region other than the encrypted region is processed as the original image instead of the real part.

For example, the second image may be divided into patches of 16×16 in size.

The processor 110 flattens each of the plurality of patches and performs position embedding to generate input vectors (S52). The input vectors may be temporarily or long-term stored in the memory 200.

For example, each patch may be flattened to a size of 1×256. Each flattened patch may be embedded into a size of 1×768 including positional information and included as an input vector.

The processor 110 inputs the input vectors into the second transformer 221 to generate a second feature vector. The second feature vector may be temporarily or long-term stored in the memory 200.

The second transformer 221 includes a Vision Transformer (ViT) structure.

The processor 110 inputs the second feature vector into the MLP head 222 to generate classification information.

The processor 110 may provide the generated classification information (S40). Specifically, the processor 110 may display the generated classification information on the display 140 or transmit it to an external terminal (not shown).

In an exemplary embodiment of the present disclosure, both the first model 210 and the second model 220 are trained to infer caption information and classification information, respectively, from the second image in which the first image is partially encrypted. Accordingly, the present disclosure can achieve two objectives simultaneously-protecting personal information while extracting features of the image.

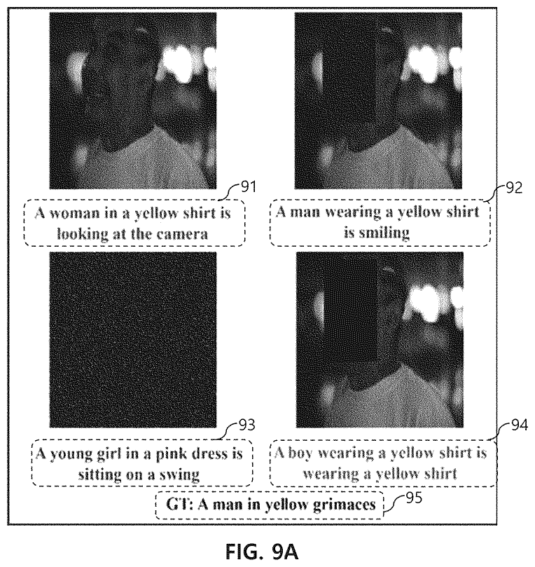

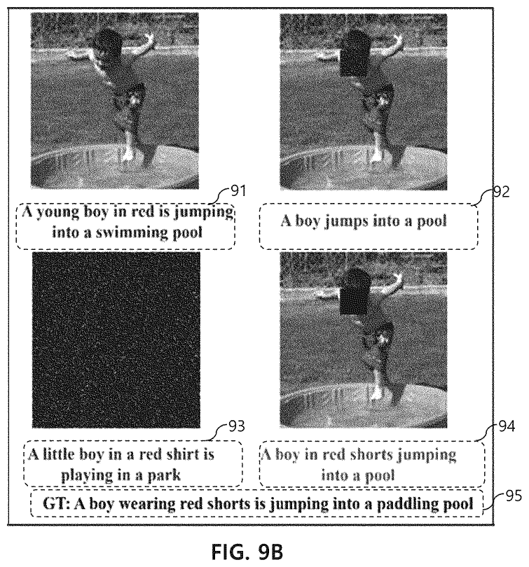

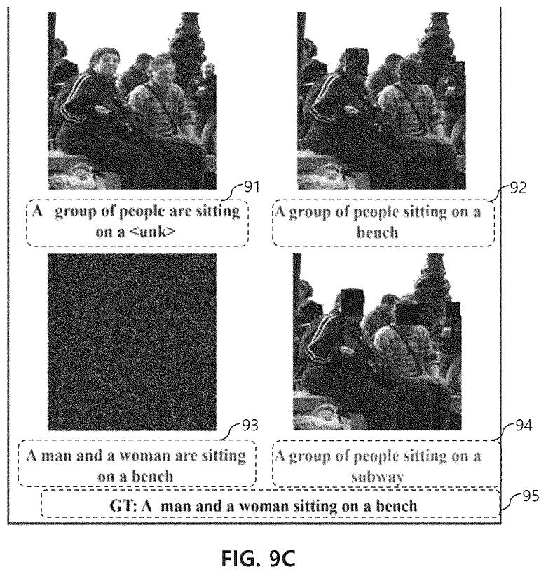

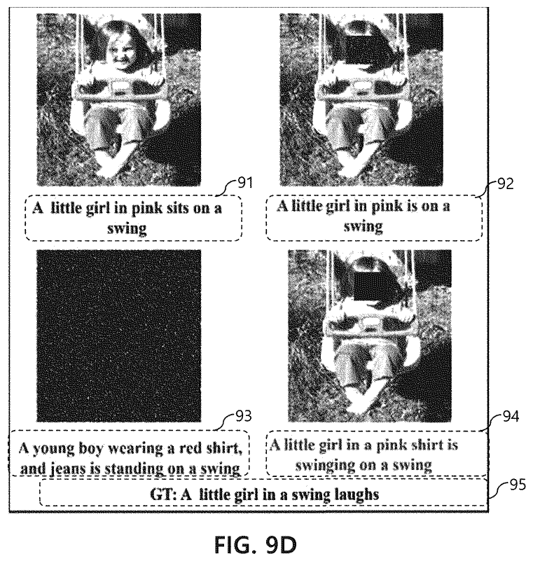

FIGS. 9A to 9D illustrate captions generated by the image data processing method according to an exemplary embodiment of the present disclosure, together with captions generated by another method and ground-truth captions.

In FIGS. 9A to 9D, a first caption 91, a second caption 92, a third caption 93, a fourth caption 94, and a ground-truth caption 95 are shown, respectively.

The first caption 91 is a caption inferred by a model trained to extract a caption from an original image. The second caption 92 is a caption inferred by a model trained to extract a caption from a second image in which the original image is partially encrypted, as in an exemplary embodiment of the present disclosure. The third caption 93 is a caption inferred by a model trained to extract a caption from a third image in which the entire image is encrypted. The fourth caption 94 is a caption inferred by a model trained to extract a caption from an image that is partially block-masked.

Referring to FIGS. 9A to 9D, it can be seen that the second caption 92 is semantically closer to the ground-truth caption 95 than the first caption 91, the third caption 93, or the fourth caption 94.

The terminology used in the present application is intended merely to describe specific embodiments and is not intended to limit the present disclosure. In the present application, the terms “comprise or include” or “have” and the like are intended to specify the presence of stated features, numerals, steps, operations, elements, components, or combinations thereof, but should be understood as not precluding the possibility of the presence or addition of one or more other features, numerals, steps, operations, elements, components, or combinations thereof.

What is claimed is:

1. A deep learning-based method for processing partially encrypted image data, implemented by a computer, the method comprising:
receiving a first image;
partially encrypting at least a portion of the first image to generate a second image in the form of complex numbers;
extracting a first feature map and a second feature map by respectively inputting a real component and an imaginary component of the second image into a first encoder and a second encoder;
generating caption information by inputting a feature vector, generated by concatenating and flattening the first feature map and the second feature map, into a transformer-based caption generation model;
generating classification information by inputting the second image into a Vision Transformer (ViT)-based classification model; and
outputting or storing at least one of the caption information and the classification information,
wherein the partially encrypted region corresponds to a predetermined region requiring privacy protection.

2. The method of claim 1,
wherein the partial encryption is performed according to a Double Random Phase Encoding (DRPE) scheme,
and wherein a first phase mask and a second phase mask used in the DRPE process are composed of random phases that are independently generated from each other.

3. The method of claim 1, wherein an encrypted region of the second image is stored separately as a real component and an imaginary component.

4. The method of claim 1, wherein a real component and an imaginary component of the second image are respectively input into a first encoder and a second encoder based on a ResNet-50 architecture to extract a first feature map and a second feature map.

5. The method of claim 1, wherein the transformer-based caption generation model comprises an encoder-decoder structure that performs cross-attention between feature vectors of a real component and an imaginary component.

6. The method of claim 1,
wherein the predetermined region requiring privacy protection includes a face, a body, or a sensitive object region,
and wherein an encryption target region is automatically selected according to predefined coordinates or object recognition results.

7. The method of claim 1,
wherein the second image is divided into a plurality of patches,
each patch is converted into a position-embedded input vector and input into a Vision Transformer (ViT)-based classification model,
and the classification model outputs a classification result through a Multi-Layer Perceptron (MLP) head.

8. The method of claim 1, wherein the first image is an image requiring privacy protection and is one of a surveillance image, a medical image, and an autonomous driving image.

9. A computer-readable medium for deep learning-based partially encrypted image data processing, the computer-readable medium being non-transitory and storing instructions that, when executed by a processor, cause the processor to perform the method of claim 1.

10. A device for deep learning-based partially encrypted image data processing, comprising:
a memory storing a plurality of instructions; and
a processor configured to execute the instructions,
wherein the processor is configured to:
receive a first image;
partially encrypt at least a portion of the first image using a Double Random Phase Encoding (DRPE) scheme to generate a second image in the form of complex numbers;
extract a first feature map and a second feature map by respectively inputting a real component and an imaginary component of the second image into a first encoder and a second encoder;
generate caption information by inputting a feature vector, generated by concatenating and flattening the first feature map and the second feature map, into a transformer-based caption generation model;
generate classification information by inputting the second image into a Vision Transformer (ViT)-based classification model; and
transmit at least one of the caption information and the classification information to an external terminal or output it through a display.
